(19) United States
(12) Patent Application Publication
(10) Pub. No.: US 2021/0279561 A1
(43) Pub. Date: Sep. 9, 2021

(54) COMPUTATIONAL PROCESSING SYSTEM, SENSOR SYSTEM, COMPUTATIONAL PROCESSING METHOD, AND PROGRAM

(71) Applicant: PANASONIC INTELLECTUAL PROPERTY MANAGEMENT CO., LTD., Osaka (JP)

(72) Inventors: Kazushi YOSHIDA, Osaka (JP); Hiroki YOSHINO, Nara (JP); Miori HIRAIWA, Osaka (JP); Susumu FUKUSHIMA, Saitama (JP)

(21) Appl. No.: 17/254,669

(22) PCT Filed: Jun. 19, 2019
(86) PCT No.: PCT/JP2019/024183

§ 371 Date: Dec. 21, 2020

(30) Foreign Application Priority Data
Jul. 3, 2018 (JP) 2018-127160

(51) Int. Cl. G06N 3/063; G06N 3/08

(52) U.S. Cl. CPC G06N 3/0635; G06N 3/08

(57) ABSTRACT

A computational processing system includes an input unit, an output unit, and a computing unit. The input unit receives a plurality of detection signals from a sensor group that is a set of a plurality of sensors. The output unit outputs two or more types of physical quantities out of multiple types of physical quantities included in the plurality of detection signals. The computing unit computes, based on the plurality of detection signals received by the input unit, the two or more types of physical quantities by using a learned neural network.

### TECHNICAL FIELD

The present disclosure generally relates to a computational processing system, a sensor system, a computational processing method, and a program. More particularly, the present disclosure relates to a computational processing system, a sensor system, a computational processing method, and a program, all of which are configured or designed to process multiple types of physical quantities by computational processing.

### BACKGROUND ART

Patent Literature 1 discloses a position detection device for calculating coordinate values of a position specified by a position indicator based on a plurality of detection values obtained based on a distance between a plurality of loop coils forming a sensing unit and the position indicator to be operated on the sensing unit. An AC voltage according to the position specified by the position indicator is induced on the plurality of loop coils. The AC voltage induced on the plurality of loop coils is converted into a plurality of DC voltages. A neural network converts the plurality of DC voltages into two DC voltages corresponding to the X and Y coordinate values of the position specified by the position indicator.

The position detection device (computational processing system) of Patent Literature 1 just outputs, based on a signal (i.e., voltage induced on the loop coils) representing a single type of received physical quantity, another type of physical quantity (coordinate values of the position indicator) different from the received one. Thus, when receiving a detection signal from a sensor having sensitivity to multiple types of physical quantities, such a computational processing system cannot extract an arbitrary physical quantity from the detection signal, which is a problem with the computational processing system of Patent Literature 1.

### CITATION LIST

### Patent Literature

Patent Literature 1: JP H05-094553 A

### SUMMARY OF INVENTION

It is therefore an object of the present disclosure to provide a computational processing system, a sensor system, a computational processing method, and a program, all of which are configured or designed to extract, when receiving a detection signal from a sensor having sensitivity to multiple types of physical quantities, an arbitrary physical quantity from the detection signal.

A computational processing system according to an aspect of the present disclosure includes an input unit, an output unit, and a computing unit. The input unit receives a plurality of detection signals from a sensor group that is a set of a plurality of sensors. The output unit outputs two or more types of physical quantities out of multiple types of physical quantities included in the plurality of detection signals. The computing unit computes, based on the plurality of detection signals received by the input unit, the two or more types of physical quantities by using a learned neural network.

A sensor system according to another aspect of the present disclosure includes the computational processing system described above and the sensor group.

A computational processing method according to still another aspect of the present disclosure includes: computing, based on a plurality of detection signals received from a sensor group that is a set of a plurality of sensors, two or more types of physical quantities, out of multiple types of physical quantities included in the plurality of detection signals, by using a learned neural network, and outputting the two or more types of physical quantities thus computed.

A program according to yet another aspect of the present disclosure is designed to cause one or more processors to perform the computational processing method described above.

### BRIEF DESCRIPTION OF DRAWINGS

FIG. 1 is block diagram schematically illustrating a computational processing system and sensor system according to an exemplary embodiment of the present disclosure;

FIG. 2 schematically illustrates a neural network for use in a computing unit of the computational processing system;

FIG. 3A illustrates an exemplary model of a neuron for the computational processing system;

FIG. 3B illustrates a neuromorphic element simulating the model of the neuron shown in FIG. 3A;

FIG. 4 is a schematic circuit diagram illustrating an exemplary neuromorphic element for the computational processing system;

FIG. 5 is a block diagram schematically illustrating a computational processing system according to a comparative example;

FIG. 6 shows an exemplary correlation between the signal value of a detection signal provided from a sensor and the temperature of an environment where the sensor is placed;

FIG. 7 shows an approximation result of the signal value of the detection signal provided from the sensor by a computational processing system according to an exemplary embodiment of the present disclosure;

FIG. 8 shows the accuracy of approximation of the signal value of the detection signal provided from the sensor by the computational processing system; and

FIG. 9 shows how a correction circuit of a computational processing system according to a comparative example makes correction to the detection signal provided from the sensor.

### DESCRIPTION OF EMBODIMENTS

(1) Overview

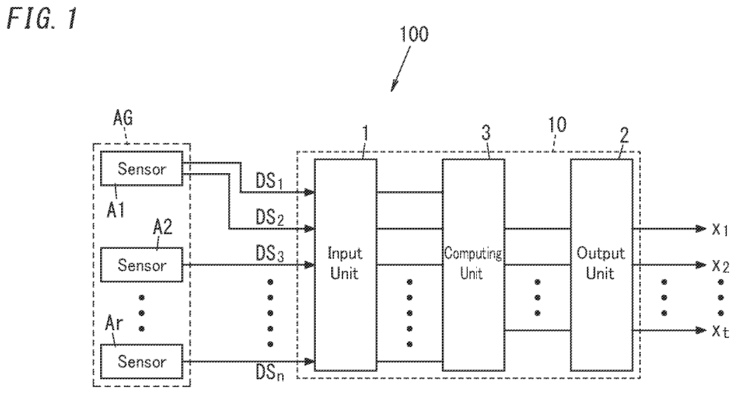

As shown in FIG. 1, a computational processing system 10 according to an exemplary embodiment forms part of a sensor system 100 and may be used along with a sensor group AG, which is a set of a plurality of sensors A1, . . . , Ar (where “r” is an integer equal to or greater than two). In other words, the sensor system 100 includes the computational processing system 10 and the sensor group AG. In this case, the plurality of sensors A1, . . . , Ar may be microelectromechanical systems (MEMS) devices, for example, and are mutually different sensors. The sensor group AG may include, for example, a sensor having sensitivity to a single type of physical quantity, a sensor having sensitivity to two types of physical quantities, and a sensor having sensitivity to three or more types of physical quantities. As used herein, the “physical quantity” is a quantity representing a physical property and/or condition of the detection target. Examples of physical quantities include acceleration, angular velocity, pressure, temperature, humidity, and light quantity. In this embodiment, even though their magnitudes are the same, the acceleration in an x-axis direction, the acceleration in a y-axis direction, and the acceleration in a z-axis direction will be regarded as mutually different types of physical quantities.

Note that in each of the plurality of sensors A1, . . . , Ar, the physical quantity to be sensed may be the same as the physical quantity to be sensed by any other sensor A1, . . . , Ar. That is to say, the sensor group AG may include a plurality of temperature sensors or a plurality of pressure sensors, for example.

As used herein, the phrase “the sensor has sensitivity to multiple types of physical quantities” has the following meaning. Specifically, a normal acceleration sensor, for example, outputs a detection signal with a signal value (e.g., a voltage value in this case) corresponding to the magnitude of the acceleration sensed. That is to say, the acceleration sensor has sensitivity to acceleration. Meanwhile, the acceleration sensor is also affected by the temperature, humidity, or any other parameter of an environment where the acceleration sensor is placed. Therefore, the signal value of the detection signal output by the acceleration sensor does not always represent the acceleration per se but will be a value affected by a physical quantity, such as temperature or humidity, other than acceleration.

As can be seen, the acceleration sensor has sensitivity to not only acceleration but also temperature or humidity as well. Thus, it can be said that the acceleration sensor has sensitivity to multiple types of physical quantities. The same statement applies to not just the acceleration sensor but also other sensors, such as a temperature sensor, dedicated to sensing other physical quantities. That is to say, each of those other sensors may also have sensitivity to multiple types of physical quantities. As used herein, the “environment” refers to a predetermined space (such as a closed space) where the detection target is present.

The computational processing system 10 includes an input unit 1, an output unit 2, and a computing unit 3.

The input unit 1 is an input interface which receives a plurality of detection signals DS₁, . . . , DSₙ (where “n” is an integer equal to or greater than two) from the sensor group AG. In this case, if the sensor A1 is an acceleration sensor, for example, the sensor A1 may output two detection signals, namely, a detection signal including the result of detection of the acceleration in the x-axis direction and a detection signal including the result of detection of the acceleration in the y-axis direction. That is to say, each of the plurality of sensors A1, . . . , Ar is not always configured to output a single detection signal but may also be configured to output two or more detection signals. Thus, the number of the plurality of sensors A1, . . . , Ar does not always agree one to one with the number of the plurality of detection signals DS₁, . . . , DSₙ.

The output unit 2 is an output interface which outputs at least two types of physical quantities x₁, . . . , xₜ (where “t” is an integer equal to or greater than two and equal to or less than “k”) out of multiple types of physical quantities x₁, . . . , xₖ (where “k” is an integer equal to or greater than two) included in the plurality of detection signals DS₁, . . . , DSₙ. As used herein, the “physical quantity” refers to information (data) about the physical quantity. The “information about the physical quantity” may be, for example, a numerical value representing the physical quantity.

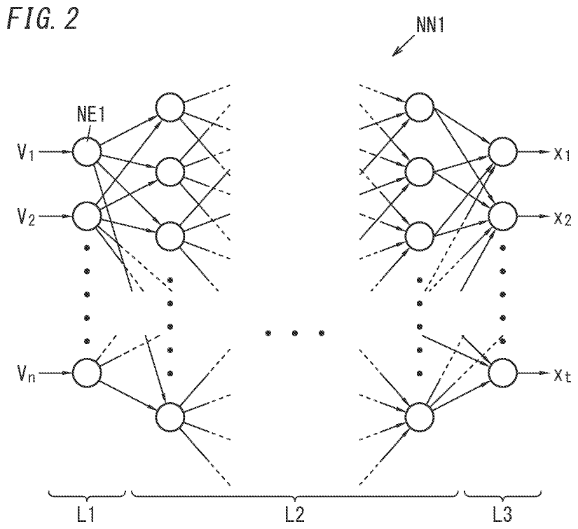

The computing unit 3 computes, based on the plurality of detection signals DS₁, . . . , DSₙ received by the input unit 1, the two or more types of physical quantities x₁, . . . , xₜ. by using a learned neural network NN1 (see FIG. 2). That is to say, the computing unit 3 performs, based on the signal values (e.g., voltage values in this example) of the plurality of detection signals DS₁, . . . , DSₙ as input values, computational processing for computing the two or more types of physical quantities x₁, . . . , xₜ on an individual basis by using the neural network NN1.

Thus, the computational processing system 10 according to this embodiment achieves the advantage of allowing, when receiving detection signals DS₁, . . . , DSₙ from a sensor group AG having sensitivity to multiple types of physical quantities x₁, . . . , xₖ, an arbitrary physical quantity x₁, . . . , xₜ to be extracted from the detection signals DS₁, . . . , DSₙ.

(2) Details

Next, the computational processing system 10 and sensor system 100 according to this embodiment will be described in detail with reference to FIGS. 1-4. The sensor system 100 according to this embodiment includes the sensor group AG consisting of the plurality of sensors A1, . . . , Ar and the computational processing system 10 as described above. Also, the computational processing system 10 according to this embodiment includes the input unit 1, the output unit 2, and the computing unit 3 as described above. In this embodiment, the computational processing system 10 is formed by implementing the input unit 1, the output unit 2, and the computing unit 3 on a single board.

In addition, according to this embodiment, the plurality of sensors A1, . . . , Ar are implemented on the single board, and thereby placed in the same environment. As used herein, “the same environment” refers to an environment in which when an arbitrary type of physical quantity varies, the physical quantity may vary in the same pattern. For example, if the arbitrary type of physical quantity is temperature, then temperature may vary in the same pattern at any position under the same environment. Under the same environment, the plurality of sensors A1, . . . , Ar may be arranged to be spaced apart from each other. Note that the board on which the computational processing system 10 is implemented may be the same as, or different from, the board on which the plurality of sensors A1, . . . , Ar are implemented.

The input unit 1 is an input interface which receives the plurality of detection signals DS₁, . . . , DSₙ from the sensor group AG. The input unit 1 outputs the plurality of detection signals DS₁, . . . , DSₙ thus received to the computing unit 3. In other words, the signal values (voltage values) V₁, . . . , Vₙ of the plurality of detection signals DS₁, . . . , DSₙ received by the input unit 1 are respectively input to a plurality of neurons NE1 (to be described later) in an input layer L1 (to be described later) of the neural network NN1 as shown in FIG. 2.

In this embodiment, the signal values V₁, . . . , Vₙ of the plurality of detection signals DS₁, . . . , DSₙ input to the plurality of neurons NE1 in the input layer L1 have been normalized by performing appropriate normalization processing on the input unit 1. In the following description, unless otherwise stated, the signal values V₁, . . . , Vₙ of the plurality of detection signals DS₁, . . . , DSₙ are supposed to be normalized values.

The output unit 2 is an output interface which outputs at least two types of physical quantities x₁, . . . , xₜ out of multiple types of physical quantities x₁, . . . , xₖ included in the plurality of detection signals DS₁, . . . , DSₙ. In this embodiment, the two or more types of physical quantities x₁, . . . , xₜ include at least two types of physical quantities selected from the group consisting of acceleration, angular velocity, temperature, and stress applied to the sensors A1, . . . , Ar.

The output unit 2 is supplied with output signals of the plurality of neurons NE1 in an output layer L3 (to be described later; see FIG. 2) of the neural network NN1. Each of these output signals includes information about its associated single type of physical quantity x₁, . . . , xₜ. Thus, information about two or more types of physical quantities x₁, . . . , xₜ is supplied on an individual basis to the output unit 2. The output unit 2 outputs the information about these two or more types of physical quantities x₁, . . . , xₜ to another system (such as an engine control unit (ECU)) outside of the computational processing system 10 (hereinafter referred to as an “different system”). Note that the output unit 2 may output the information, provided by the output layer L3, about the two or more types of physical quantities x₁, . . . , xₜ to the external different system either as it is or after having converted the information to data processible for the external different system.

The computing unit 3 is configured to compute, based on the signal values V₁, . . . , Vₙ of the plurality of detection signals DS₁, . . . , DSₙ received by the input unit 1, the two or more types of physical quantities x₁, . . . , xₜ by using the learned neural network NN1. The neural network NN1 is obtained by machine learning (such as a deep learning) using the signal values V₁, . . . , Vₙ of the plurality of detection signals DS₁, . . . , DSₙ as input values.

As shown in FIG. 2, the neural network NN1 is made up of a single input layer L1, one or more intermediate layers (hidden layers) L2, and a single output layer L3. Each of the input layer L1, one or more intermediate layers L2, and output layer L3 is made up of a plurality of neurons (nodes) NE1. Each of the neurons NE1 in the one or more intermediate layers L2 and the output layer L3 is coupled to a plurality of neurons NE1 in a layer preceding the given layer by at least one. An input value to each of the neurons NE1 in the one or more intermediate layers L2 and the output layer L3 is the sum of the products of respective output values of the plurality of neurons NE1 in that layer preceding the given layer by at least one and respective unique weighting coefficients. In the one or more intermediate layers L2, the output value of each neuron NE1 is obtained by substituting the input value into an activation function.

In this embodiment, the signal values V₁, . . . , Vₙ of the plurality of detection signals DS₁, . . . , DSₙ are input to the plurality of neurons NE1 in the input layer L1. That is to say, the number of the neurons NE1 included in the input layer L1 is equal to the number of the plurality of detection signals DS₁, . . . , DSₙ. Also, in this embodiment, each of the plurality of neurons NE1 in the output layer L3 provides an output signal including a corresponding type of physical quantity out of the two or more types of physical quantities x₁, . . . , xₜ. That is to say, the number of the neurons NE1 included in the output layer L3 is equal to the number of the types of physical quantities x₁, . . . , xₜ.

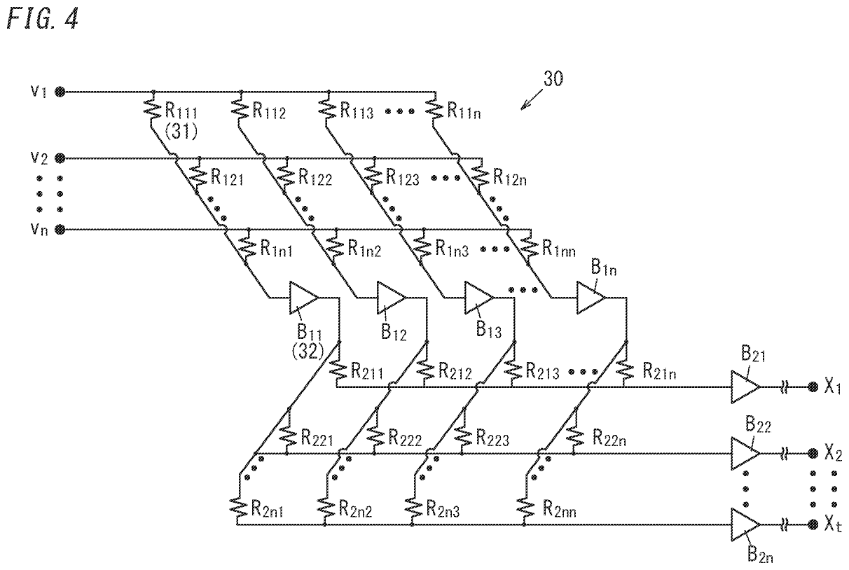

In this embodiment, the neural network NN1 is implemented as a neuromorphic element 30 including one or more cells 31 as shown in FIG. 4, for example. In other words, the computing unit 3 includes the neuromorphic element 30.

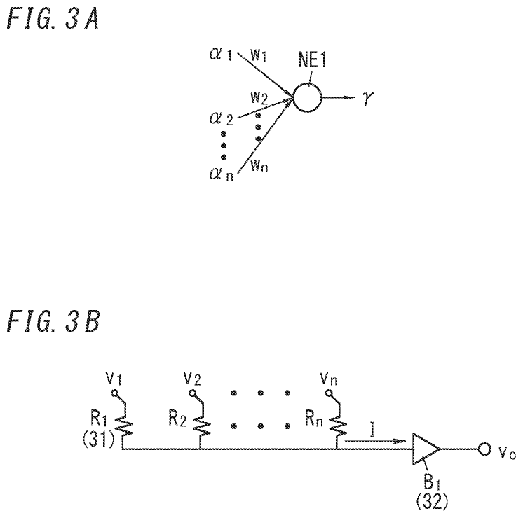

For example, the model of the neurons NE1 shown in FIG. 3A may be simulated by the neuromorphic element shown in FIG. 3B. In the example illustrated in FIG. 3A, the neuron NE1 receives products of the respective output values α₁, . . . , αₙ of the plurality of neurons NE1 in the layer preceding the given layer by at least one and their associated weighting coefficients w₁, . . . , wₙ. Thus, the input value α of this neuron NE1 is given by the following equation:

$$α = {\sum }_{i = 1}^{n} {a}_{i} {w}_{i} . \qquad [ Mathematical Equation 1 ]$$

Meanwhile, the output value γ of this neuron NE1 is obtained by substituting the input value α of the neuron NE1 into the activation function.

The neuromorphic element 30 shown in FIG. 3B includes a plurality of resistive elements R₁, . . . , Rₙ serving as first cells and an amplifier circuit B₁ serving as a second cell 32. The plurality of resistive elements R₁, . . . , Rₙ have their respective first terminals electrically connected to a plurality of input potentials v₁, . . . , vₙ, respectively, and have their respective second terminals electrically connected to an input terminal of the amplifier circuit B₁. Thus, an input current I flowing into the input terminal of the amplifier circuit B₁ is given by the following equation:

$$I = {\sum }_{i = 1}^{n} {v}_{i} \cdot ( \frac{1}{{R}_{i}} ) \qquad [ Mathematical Equation 2 ]$$

The amplifier circuit B₁ may include, for example, one or more operational amplifiers. The output potential vₒ of the amplifier circuit B₁ varies according to the magnitude of the input current I. In this embodiment, the amplifier circuit B₁ is configured such that the output potential thereof vₒ is simulatively represented by a sigmoid function that uses the input current I as a variable.

That is to say, the plurality of input potentials v₁, . . . , vₙ respectively correspond to the plurality of output values α₁, . . . , αₙ of the neuron NE1 model shown in FIG. 3A. Meanwhile, the inverse numbers of the resistance values of the plurality of resistive elements R₁, . . . , Rₙ respectively correspond to the plurality of weighting coefficients w₁, . . . , wₙ of the neuron NE1 model shown in FIG. 3A. Also, the input current I corresponds to the input value a in the neuron NE1 model shown in FIG. 3A. Furthermore, the output potential vₒ corresponds to the output value γ in the neuron NE1 model shown in FIG. 3A.

As can be seen, the first cells 31 (e.g., resistive elements in this example) simulate the weighting coefficients w₁, . . . , wₙ between the neuron NE1 in the neural network NN1. In this embodiment, the neuromorphic element 30 (see FIG. 4) includes resistive elements (i.e., the first cells 31) representing, as resistance values, the weighting coefficients w₁, . . . , wₙ between the neuron NE1 in the neural network NN1. For example, the first cells 31 may be each implemented as a nonvolatile storage element such as phase-change memory (PCM) or a resistive random-access memory (ReRAM). As the nonvolatile storage element, a spin transfer torque random access memory (ST-RAM) may also be used, for example.

In addition, the amplifier circuit B₁ simulates the neuron NE1. In this embodiment, the amplifier circuit B₁ outputs a signal representing the magnitude of the input current I. For example, the input-output characteristic of the amplifier circuit B₁ simulates a sigmoid function as an activation function. Alternatively, the activation function simulated by the input-output characteristic of the amplifier circuit B₁ may also be another nonlinear function such as a step function or a rectified linear unit (Relu) function.

In the example illustrated in FIG. 4, a neural network NN1 including a single input layer L1, two intermediate layers L2, and a single output layer L3 is simulated by the neuromorphic element 30. In the example illustrated in FIG. 4, the input potentials v₁, . . . , vₙ respectively correspond to the signal values V₁, . . . , Vₙ of the plurality of detection signals DS₁, . . . , DSₙ. The output potentials X₁, . . . , Xₜ respectively correspond to the output signals of the plurality of neurons NE1 in the output layer L3. A plurality of first amplifier circuits B₁₁, . . . , B₁ₙ simulate the plurality of neurons NE1 in the first intermediate layer L2. A plurality of second amplifier circuits B₂₁, . . . , B₂ₙ simulate the plurality of neurons NE1 in the second intermediate layer L2. A plurality of first resistive elements R₁₁₁, . . . , R₁ₙₙ respectively simulate the weighting coefficients between the plurality of neurons NE1 in the input layer L1 and the plurality of neurons NE1 in the first intermediate layer L2. A plurality of second resistive elements R₂₁₁, . . . , R₂ₙₙ respectively simulate the weighting coefficients between the plurality of neurons NE1 in the first intermediate layer L2 and the plurality of neurons NE1 in the second intermediate layer L2. Note that illustration of the resistive elements and amplifier circuits between the plurality of second amplifier circuits B₂₁, . . . , B₂ₙ and the output potentials X₁, . . . , Xₜ is omitted. As can be seen, the neural network NN1 may be simulated by the neuromorphic element 30 including one or more first cells 31 and one or more second cells 32.

(3) Operation

Next, it will be described how the computational processing system 10 according to this embodiment operates. In the following description, a learning phase in which a learned neural network NN1 is established by machine learning before the computational processing system 10 is used will be described. After that, a deduction phase in which the computational processing system 10 is used will be described.

(3.1) Learning Phase

The machine learning in the learning phase may be carried out at a learning center, for example. That is to say, a place where the computational processing system 10 is used in the deduction phase (e.g., a vehicle such as an automobile) and a place where the machine learning is carried out in the learning phase may be different from each other. At the learning center, machine learning of the neural network NN1 is carried out using one or more processors. To carry out the machine learning, the weighting coefficients of the neural network NN1 have been initialized. As used herein, the “processor” may include not only general-purpose processors such as a central processing unit (CPU) and a graphics processing unit (GPU) but also a dedicated processor to be used exclusively for computational processing in the neural network NN1.

First of all, learning data for use in learning of the neural network NN1 is acquired. Specifically, the sensor group AG is placed in an environment for learning. Then, in the environment for learning, the signal values V₁, . . . , Vₙ of the plurality of detection signals DS₁, . . . , DSₙ are received from the sensor group AG with one type of physical quantity, out of the two or more types of physical quantities x₁, . . . , xₜ varied stepwise in the environment for learning. In the following description, a combination of the two or more types of physical quantities x₁, . . . , xₜ and the signal values V₁, . . . , Vₙ in the environment for learning will be hereinafter referred to as a “data set for learning.”

For example, if the physical quantity to vary is temperature, the signal values V₁, . . . , Vₙ are obtained with the temperature in the environment for learning varied stepwise. In this case, if the temperature is varied in ten steps, then ten data sets for learning about temperature need to be acquired. After that, this processing will be performed repeatedly for each and every one of the two or more types of physical quantities x₁, . . . , xₜ. For example, if signal values V₁, . . . , Vₙ are obtained with each of three types of physical quantities varied in five steps, then 125 (=5³) data sets for learning will be acquired.

Next, learning of the neural network NN1 is carried out using the plurality of data sets for learning thus acquired. Specifically, the one or more processors perform computational processing on each of the plurality of data sets for learning with the signal values V₁, . . . , Vₙ that have been obtained entered into the plurality of neurons NE1 in the input layer L1. Then, the one or more processors carry out error back propagation processing using the output values of the plurality of neurons NE1 in the output layer L3 and teacher data. As used herein, the “teacher data” refers to two or more types of physical quantities x₁, . . . , xₜ when the signal values V₁, . . . , Vₙ are the input values for the neural network NN1 in the data sets for learning. That is to say, the two or more types of physical quantities x₁, . . . , xₜ serve as teacher data corresponding to the plurality of neurons NE1 in the output layer L3. In the error back propagation processing, the one or more processors update the weighting coefficients of the neural network NN1 to minimize the error between the output values of the respective neurons NE1 in the output layer L3 and their corresponding teacher data (i.e., their corresponding physical quantities).

Subsequently, the one or more processors attempt to optimize the weighting coefficients of the neural network NN1 by performing the error back propagation processing on every data set for learning. In this manner, learning of the neural network NN1 is completed. That is to say, the set of weighting coefficients for the neural network NN1 is a learned model generated by machine learning algorithm based on the signal values V₁, . . . , Vₙ of the plurality of detection signals DS₁, . . . , DSₙ.

When the learning of the neural network NN1 is completed, the learned neural network NN1 is loaded into the computing unit 3. Specifically, the neuromorphic element 30 of the computing unit 3 writes the weighting coefficients for the learned neural network NN1 as inverse numbers of the resistance values of their associated first cells 31.

(3.2) Deduction Phase

In the deduction phase, the sensor group AG is placed in a different environment from the environment for learning, i.e., placed in an environment where the physical quantity should be actually detected by the sensor group AG. The input unit 1 of the computational processing system 10 receives the plurality of detection signals DS₁, . . . , DSₙ from the sensor group AG either at regular intervals or in real time. The computing unit 3 performs, using the learned neural network NN1, computational processing on the signal values V₁, . . . , Vₙ of the plurality of detection signals DS₁, . . . , DSₙ received by the input unit 1 as input values. That is to say, the signal values V₁, . . . , Vₙ are respectively input to the plurality of neurons NE1 n the input layer L1 of the learned neural network NN1. Then, the plurality of neurons NE1 in the output layer L3 send output signals, including respectively corresponding physical quantities, to the output unit 2. In response, the output unit 2 outputs information provided by the output layer L3 about the two or more types of physical quantities x₁, . . . , xₜ to a different system outside of the computational processing system 10.

For example, suppose the sensor group AG includes three sensors, namely, a first sensor having sensitivity to each of acceleration, temperature, and humidity, a second sensor having sensitivity to each of angular velocity, temperature, and humidity, and a third sensor having sensitivity to each of pressure, temperature, and humidity. In that case, the input unit 1 receives a detection signal DS₁ from the first sensor, a detection signal DS₂ from the second sensor, and a detection signal DS₃ from the third sensor. Then, the three detection signals DS₁, DS₂, DS₃ include five types of physical quantities x₁, x₂, x₃, x₄, x₅ (which are acceleration, angular velocity, pressure, temperature, and humidity, respectively).

In this case, in the learning phase, learning of the neural network NN1 is carried out to output two types of physical quantities x₁, x₄ (i.e., acceleration and temperature) based on the detection signals DS₁, DS₂, DS₃ and then the learned neural network NN1 is loaded into the computing unit 3. In this case, on receiving the detection signals DS₁, DS₂, DS₃, the computational processing system 10 will be able to output acceleration and temperature on an individual basis.

As can be seen from the foregoing description, the computational processing system 10 according to this embodiment achieves the advantage of allowing, when receiving the detection signals DS₁, . . . , DSₙ from the sensor group AG having sensitivity to the multiple types of physical quantities x₁, . . . , xₖ, an arbitrary physical quantity x₁, . . . , xₜ to be extracted from the detection signals DS₁, . . . , DSₙ. That is to say, according to this embodiment, even when sensors having sensitivity to multiple types of physical quantities x₁, . . . , xₖ are used as the sensors A1, . . . , Ar, any arbitrary physical quantity may also be extracted without being affected by any other physical quantity.

(4) Performance

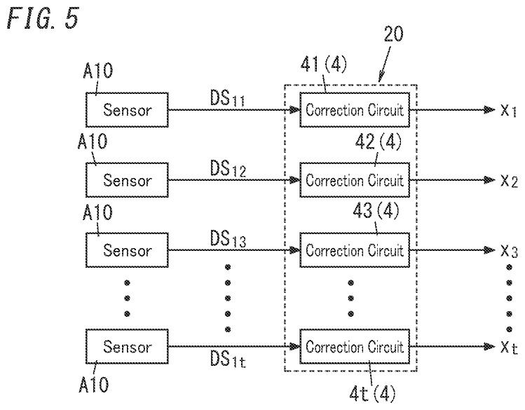

Next, the performance of the computational processing system 10 according to this embodiment will be described in comparison with a computational processing system 20 according to a comparative example. The computational processing system 20 according to the comparative example includes a plurality of correction circuits 41, . . . , 4t as shown in FIG. 5. In the following description, if there is no need to distinguish the correction circuits 41, . . . , 4t from each other, these correction circuits 41, . . . , 4t will be hereinafter collectively referred to as “correction circuits 4.” The correction circuits 4 may be implemented as, for example, integrated circuits such as application specific integrated circuits (ASICs).

Each of the correction circuits 41, . . . , 4t receives a corresponding detection signal DS₁₁, . . . , DS₁ₜ. The detection signals DS₁₁, . . . , DS₁ₜ are signals sent from their corresponding sensors A10. In this case, each of these sensors A10 is a sensor dedicated to detecting a single type of physical quantity. For example, if the sensor A10 is an acceleration sensor, the sensor A10 outputs a detection signal with a signal value (e.g., a voltage value) corresponding to the magnitude of the acceleration detected. In addition, the shape of the sensor A10, the layout of its electrodes, or any other parameter is specially designed to reduce the chances of the signal value of the detection signal being affected by a physical quantity (such as the temperature or humidity) other than the acceleration of the environment in which the sensor A10 is placed.

Each of the correction circuits 41, . . . , 4t converts the signal value of the incoming detection signal DS₁₁, . . . , DS₁ₜ into a corresponding physical quantity x₁, . . . , xₜ using an approximation function and outputs the physical quantity x₁, . . . , xₜ thus converted. That is to say, the detection accuracy of the physical quantities x₁, . . . , xₜ depends on the approximation function used by the correction circuits 41, . . . , 4t. In the computational processing system 20 according to the comparative example, the correction circuits 41, . . . , 4t are designed such that their approximation function is a cubic function.

To quantitively compare the performance of the computational processing system 10 according to this embodiment with that of the computational processing system 20 according to the comparative example, the sensitivity of the sensors A1, . . . , Ar (or the sensors A10) to a given physical quantity is defined herein to be a “sensitivity coefficient.” It will be described below exactly how to obtain the sensitivity coefficient.

Suppose an arbitrary sensor has sensitivity to k types of physical quantities x₁, . . . , xₖ. In that case, the signal value (e.g., the voltage value in this example) of the detection signal output by this sensor is expressed as a function of k types of physical quantities x₁, . . . , xₖ. Then, suppose the signal value of the detection signal is to be obtained with one of the k types of physical quantities x₁, . . . , xₖ varied stepwise in the environment where the sensor is placed.

The following Table 1 summarizes, with respect to sensors, each having sensitivity to a first physical quantity, a second physical quantity, and a third physical quantity, exemplary correlations between the settings of the respective physical quantities and the voltage values of the detection signals output from the sensors. In the following table, the numbers and the numbers in parentheses indicate the order in which the signal values of the detection signals have been obtained. Also, in the following table, the first physical quantity is varied in the three stages of “d1,” “d2,” and “d3,” the second physical quantity is varied in the three stages of “e1,” “e2,” and “e3,” and the third physical quantity is varied in the three stages of “f1,” “f2,” and “f3.” In addition, in the following table, “V(1)” to “V(27)” represent the respective signal values of the detection signals. For example, “V(2)” represents the signal value of the second detection signal. That is to say, in the following exemplary table, the processing of obtaining the signal values of the detection signals is performed repeatedly for every type of physical quantity with one of the three types of physical quantities varied in three stages. Thus, the total number of signal values obtained for the detection signals becomes 27 (=33).

TABLE 1

| | 1st Physical | 2nd Physical | 3rd Physical | Signal |
|---|---|---|---|---|
| No. | Quantity | Quantity | Quantity | Value |
| 1 | d1 | e1 | f1 | V(1) |
| 2 | d1 | e1 | f2 | V(2) |
| 3 | d1 | e1 | f3 | V(3) |
| 4 | d1 | e2 | f1 | V(4) |
| 5 | d1 | e2 | f2 | V(5) |
| 6 | d1 | e2 | f3 | V(6) |
| 7 | d1 | e3 | f1 | V(7) |
| 8 | d1 | e3 | f2 | V(8) |
| 9 | d1 | e3 | f3 | V(9) |
| 10 | d2 | e1 | f1 | V(10) |
| 11 | d2 | e1 | f2 | V(11) |
| 12 | d2 | e1 | f3 | V(12) |
| 13 | d2 | e2 | f1 | V(13) |
| 14 | d2 | e2 | f2 | V(14) |
| 15 | d2 | e2 | f3 | V(15) |
| 16 | d2 | e3 | f1 | V(16) |
| 17 | d2 | e3 | f2 | V(17) |
| 18 | d2 | e3 | f3 | V(18) |
| 19 | d3 | e1 | f1 | V(19) |
| 20 | d3 | e1 | f2 | V(20) |
| 21 | d3 | e1 | f3 | V(21) |
| 22 | d3 | e2 | f1 | V(22) |
| 23 | d3 | e2 | f2 | V(23) |
| 24 | d3 | e2 | f3 | V(24) |
| 25 | d3 | e3 | f1 | V(25) |
| 26 | d3 | e3 | f2 | V(26) |
| 27 | d3 | e3 | f3 | V(27) |

In this case, if the physical quantity xₖ is normalized, the normalized physical quantity yₖ is given by the following Equation (1):

$$\begin{matrix}[ Mathematical Equation 3 ] & \\ {y}_{k ( s )} = \frac{( {x}_{k ( s )} - \overline{{x}_{k}} )}{{σ}_{{x}_{k}}} & ( 1 )\end{matrix}$$

where \tilde{x}ₖ is an average value and σₓₖ is a standard deviation.

In Equation (1), “s” represents a natural number indicating the order in which the signal values of the detection signals have been obtained. The same statement applies to Equations (2) to (4) to be described later. For example, “xₖ₍₃₎” represents the physical quantity xₖ of the third detection signal. For example, “yₖ₍₄₎” represents the normalized physical quantity yₖ of the fourth detection signal.

Also, if the signal value (voltage value) V of the detection signal is normalized, then the normalized signal value W is given by the following Equation (2). In the following Equation (2), “V₍ₛ₎” represents the signal value V of the s^{th} detection signal and “W₍ₛ₎” represents the normalized signal value W of the s^{th} detection signal.

$$\begin{matrix}[ Mathematical Equation 4 ] & \\ {W}_{( s )} = \frac{( {V}_{( s )} - \overline{V} )}{{σ}_{V}} & ( 2 )\end{matrix}$$

where V̅ is an average value and say is a standard deviation.

The normalized voltage W(s) is given by the following Equation (3) using normalized physical quantities y₁₍ₛ₎, . . . , yₖ₍ₛ₎ and the linear combination coefficients (i.e., sensitivity coefficients) a₁, . . . , aₖ of the normalized physical quantities y₁₍ₛ₎, . . . , yₖ₍ₛ₎:

[Mathematical Equation 5]

W₍ₛ₎=a₁y₁₍ₛ₎+a₂y₂₍ₛ₎+ . . . +aₖyₖ₍ₛ₎ (3)

In this case, the sensitivity coefficient aₘ of an arbitrary normalized physical quantity yₘ (where “m” is a natural number equal to or less than “k”) is given by the following Equation (4):

$$\begin{matrix}[ Mathematical Equation 6 ] & \\ {a}_{m} = \frac{{\sum }_{s = 1}^{{j}^{k}} {W}_{( s )} {y}_{m ( s )}}{\sqrt{{\sum }_{s = 1}^{{j}^{k}} {W}_{( s )}^{2}} \sqrt{{\sum }_{s = 1}^{{j}^{k}} {y}_{m ( s )}^{2}}} & ( 4 )\end{matrix}$$

In Equation (4), “j” is a natural number representing the numbers of the stages on which the physical quantity is varied in an environment where the sensor is placed. That is to say, “j^{k}” represents the total number of signal values of the detection signals in a situation where the processing of obtaining the signal values of the detection signals with one of the k types of physical quantities x₁, . . . , xₖ varied stepwise is repeatedly performed on every physical quantity. Also, the sensitivity coefficients a₁, . . . , aₖ are normalized to satisfy the condition expressed by the following Equation (5), where “ρ” is a coefficient of correlation between the normalized voltage W and the normalized physical quantities y₁, . . . , yₖ.

$$\begin{matrix}[ Mathematical Equation 7 ] & \\ {\sum }_{m = 1}^{k} {( {a}_{m} )}^{2} = {ρ}^{2} & ( 5 )\end{matrix}$$

The closer to “ρ²” the sensitivity coefficient a₁, . . . , aₖ defined as described above is, the more easily the signal value of the detection signal follows a variation in the corresponding physical quantity. The closer to zero the sensitivity coefficient a₁, . . . , aₖ defined as described above is, the less easily the signal value of the detection signal follows a variation in the corresponding physical quantity. That is to say, the sensitivity coefficient a₁, . . . , aₖ represents sensitivity to its corresponding physical quantity. Note that if the sensitivity coefficient a₁, . . . , aₖ is zero, then it comes that the sensor has no sensitivity to the corresponding physical quantity. In the following description, “ρ²=1” is supposed to be satisfied.

In this example, “βₘᵢₙ” is defined as an index indicating the performance limit of the computational processing system 20 according to the comparative example. “βₘᵢₙ” is the minimum value of “β” given by the following Equation (6):

[Mathematical Equation 8]

β=aₚ₁²·a_{q1}²·aₚ₂²·a_{q2}² (6)

In Equation (6), “aₚ₁” represents the largest sensitivity coefficient of one detection signal (hereinafter referred to as a “first detection signal”) out of two arbitrary detection signals selected from the group consisting of the plurality of detection signals DS₁₁, . . . , DS₁ₜ provided by the plurality of sensors A10. “a_{q1}” represents the largest sensitivity coefficient of the other detection signal (hereinafter referred to as a “second detection signal”) out of two arbitrary detection signals. “aₚ₂” represents the second largest sensitivity coefficient of the first detection signal. “a_{q2}” represents the second largest sensitivity coefficient of the second detection signal.

There is one “β” value for every combination of two detection signals. Thus, if the number of the plurality of detection signals DS₁₁, . . . , DS₁ₜ is “t,” then there are “ₜC₂” “β” values. “β min” is the minimum value of these “ₜC₂” “β” values.

In the computational processing system 20 according to the comparative example, if the correction circuits 4 correct the signal values of the detection signals using a cubic function as the approximation function, then the minimum value of the sensitivity (which is the square of the sensitivity coefficient of the corresponding physical quantity) of the sensors A10 that can make corrections with practicable detection accuracy is approximately “0.84.” This value of “0.84” corresponds to a coefficient of determination of a regression line when the approximation function is a cubic function that has no extreme values within the detection range of the sensors A10 (in this case, when “y=x³”).

Suppose the square of the largest sensitivity coefficient aₚ₁ of the first detection signal is “0.84,” the square of the second largest sensitivity coefficient aₚ₂ of the first detection signal is “0.16 (=1−0.84),” and all the other sensitivity coefficients are equal to zero. In the same way, suppose the square of the largest sensitivity coefficient a_{q1} of the second detection signal is “0.84,” the square of the second largest sensitivity coefficient a_{q2} of the second detection signal is “0.16 (=1−0.84),” and all the other sensitivity coefficients are equal to zero. In that case, “β min” becomes equal to “0.68.”

That is to say, if each of the plurality of sensors A10 has sensitivity that meets “βₘᵢₙ>0.68” to its corresponding physical quantity, the correction circuits 4 designed to use a cubic function as the approximation function would be able to correct, with practicable detection accuracy, the signal values of the detection signals provided by the sensors A10. On the other hand, if each of the plurality of sensors A10 has sensitivity that does not meet “βₘᵢₙ>0.68” to its corresponding physical quantity, it would be difficult for even the correction circuits 4 designed to use a cubic function as the approximation function to correct, with practicable detection accuracy, the signal values of the detection signals provided by the sensors A10. To correct, with practicable detection accuracy, the signal values of the detection signals provided by the sensors A10 even in the latter case, the correction circuits 4 should be designed to use a quartic function or a function of an even higher order as the approximation function. However, it is difficult to design such correction circuits 4 from the viewpoint of development efficiency.

That is to say, in the computational processing system 20 according to the comparative example, unless each of the plurality of sensors A10 is dedicated to detecting their corresponding physical quantity, it would be difficult for the correction circuits 4 to correct, with practicable detection accuracy, the signal values of the detection signals provided by the sensors A10.

In contrast, even if each of the plurality of sensors A1, . . . , Ar is not dedicated to detecting their corresponding physical quantity, the computational processing system 10 according to this embodiment is still able to output two or more types of physical quantities x₁, . . . , xₜ with practicable detection accuracy.

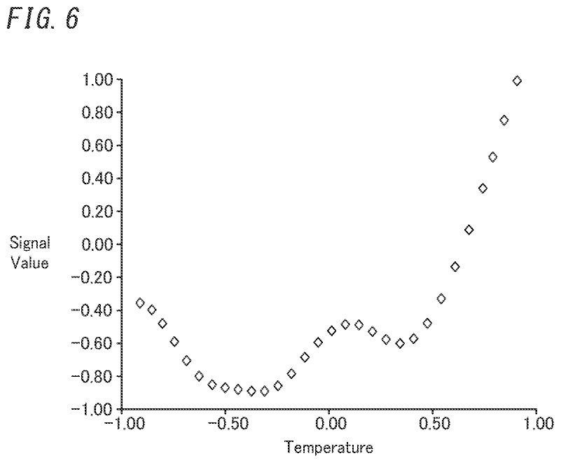

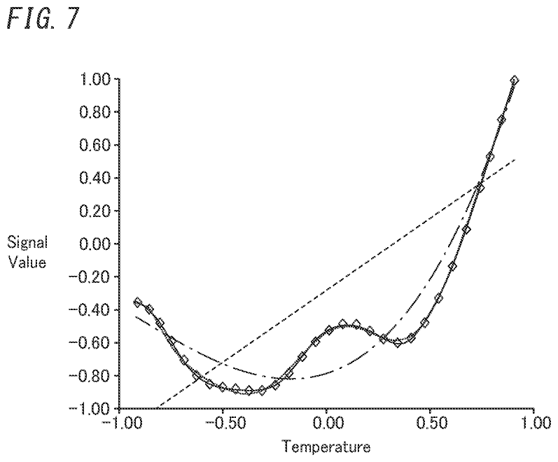

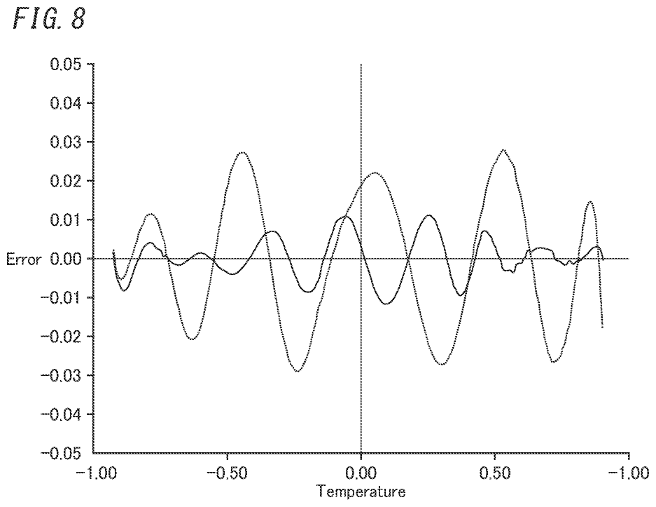

Next, it will be described, by way of example, with reference to FIGS. 6 and 7 what differences arise depending on whether the zero-point correction of a sensor with temperature dependence is made by the correction circuit as in the computational processing system 20 according to the comparative example or by using a neural network as in the computational processing system 10 according to this embodiment. FIG. 6 shows correlation between the signal values of the detection signal provided by the sensor and the temperature of the environment in which the sensor is placed. FIG. 7 shows the results of approximation of the signal values of the detection signal provided by the sensor. In FIGS. 6 and 7, the “signal value” on the axis of ordinates indicates a value normalized such that the detection signal has a maximum signal value of “1.0” and a minimum signal value of “−1.0.” Also, in FIGS. 6 and 7, the “temperature” on the axis of abscissas indicates a value normalized such that the temperature of the environment where the sensor is placed has a maximum value of “1.0” and a minimum value of “−1.0.” The same statement also applies to FIG. 8 to be referred to later. Note that when the zero-point correction is made, learning is performed in advance on the neural network using the signal values of the detection signal generated by the sensor as input values and also using the temperature of the environment where the sensor is placed as teacher data.

As shown in FIG. 7, the zero-point correction using the neural network (see the solid curve shown in FIG. 7) achieves higher approximation accuracy than the zero-point correction made by the correction circuits using a linear function as the approximation function (see the dashed line shown in FIG. 7) or the zero-point correction made by the correction circuits using a cubic function as the approximation function (see the one-dot chain curve shown in FIG. 7). In addition, the zero-point correction using the neural network achieves approximation accuracy at least comparable to, or even higher than, the one achieved by zero-point correction made by correction circuits using a quartic or even higher-order function (such as a ninth-order function in this example) (see the dotted curve shown in FIG. 7).

With this regard, FIG. 8 shows the correlation between the difference (i.e., the error) of the approximated signal values of the detection signal provided by the sensor from the actually measured values and the temperature of the environment where the sensor is placed. In FIG. 8, the “error” on the axis of ordinates indicates the error values normalized such that the maximum value of the signal values of the detection signal is “1.0” and the minimum value thereof is “−1.0.” As shown in FIG. 8, the zero-point correction using the neural network (see the solid curve shown in FIG. 8) causes less significant errors (i.e., achieves higher approximation accuracy) than the zero-point correction made by the correction circuits using a quartic or even higher-order function as the approximation function (e.g., a ninth-order function in this example) (see the dotted curve shown in FIG. 8).

As can be seen from the foregoing description, using the neural network enables zero-point correction to be made to the signal values of the detection signal provided by the sensor while achieving accuracy that is at least as high as the one achieved by the correction made by the correction circuits using a quartic or even higher-order function as the approximation function. In the example described above, the zero-point correction is made to a single sensor using the neural network. However, even if the zero-point correction is made to a plurality of sensors using the neural network, the accuracy achieved will be almost as high as the one achieved when the zero-point correction is made to the single sensor. Thus, using the learned neural network NN1 also allows the computational processing system 10 according to this embodiment to output two or more types of physical quantities x₁, . . . , xₜ with higher accuracy than when the corrections are made by the correction circuits 4 using a cubic function as the approximation function.

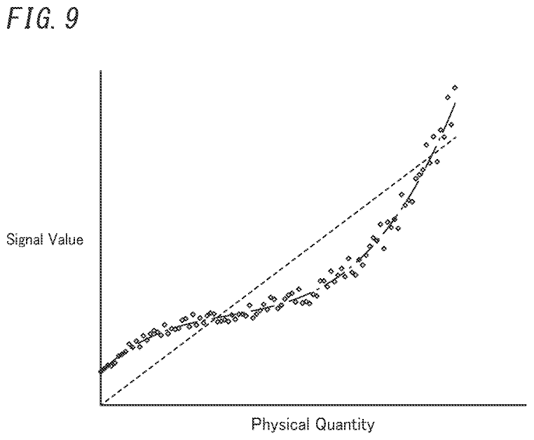

In this case, the signal values of the detection signal provided by the sensor may vary irregularly due to a systematic error and a random error, even though the signal values follow a certain tendency as shown in FIG. 9. FIG. 9 shows correlation between the signal value of the detection signal provided by the sensor and a physical quantity (such as the temperature) of the environment where the sensor is placed. The systematic error may be caused mainly because the sensor has sensitivity to multiple types of physical quantities x₁, . . . , xₖ. The systematic error may be minimized by making corrections using either a linear function (see the dashed line shown in FIG. 9) or a high-order function (see the one-dot chain curve shown in FIG. 9) as the approximation function as in the computational processing system 20 according to the comparative example, for instance. The random error may be caused mainly due to noise. The random error may be minimized by making corrections with an average value of multiple measured values obtained.

As described above, the computational processing system 20 according to the comparative example requires both corrections to the systematic error and corrections to the random error. In contrast, according to this embodiment, using the learned neural network NN1 for the detection signals DS₁, . . . , DSₙ provided by the sensor group AG having sensitivity to multiple types of the physical quantities x₁, . . . , xₖ allows the systematic error and the random error to be minimized even without making the corrections, which is an advantage of this embodiment over the comparative example.

In addition, the computational processing system 10 according to this embodiment is also applicable to even a sensor with relatively low sensitivity that does not meet “βₘᵢₙ>0.68.” The computational processing system 10 according to this embodiment is naturally applicable to a sensor with sensitivity that is high enough to meet “βₘᵢₙ>0.68.”

Furthermore, in the computational processing system 20 according to the comparative example, as the number of the sensors A10 provided increases, the number of the correction circuits 4 required increases accordingly, thus often causing a significant increase in the circuit size. In contrast, in the computational processing system 10 according to this embodiment, even when the number of the sensors A1 . . . , , Ar provided increases, the circuit size increases much less significantly, which is an advantage of the computational processing system 10 over the computational processing system 20.

In addition, if the processing of extracting an arbitrary physical quantity x₁, . . . , xₜ from the detection signals DS₁, . . . , DSₙ is performed by the computational processing system 20 according to the comparative example, then corrections using a high-order approximation function and other complicated processing would be required, thus increasing the computational load significantly. In contrast, this embodiment allows the computational load required for performing the processing of extracting an arbitrary physical quantity x₁, . . . , xₜ from the detection signals DS₁, . . . , DSₙ to be lightened, which is an advantage of the computational processing system 10 according to this embodiment over the computational processing system 20 according to the comparative example.

In this embodiment, the output unit 2 outputs two or more types of physical quantities x₁, . . . , xₜ to a different system. The different system is a system different from the computational processing system 10 (such as an ECU for automobiles) and performs the processing of receiving two or more types of physical quantities x₁, . . . , xₜ. If the different system is an ECU for an automobile, for example, the different system receives two or more types of physical quantities x₁, . . . , xₜ such as acceleration and angular velocity to perform the processing of determining the operating state of the automobile, which may be starting, stopping, or turning.

If the different system included the computational processing system 10, then the different system should perform both its own dedicated processing of receiving two or more types of physical quantities x₁, . . . , xₜ and the processing to be performed by the computing unit 3. This would increase the computational load for the different system. Meanwhile, according to this embodiment, the computational processing system 10 and the different system are two distinct systems, and the different system is configured to receive the results of the computational processing performed by the computational processing system 10 by receiving the output of the output unit 2. Thus, according to this embodiment, the different system only needs to perform its own dedicated processing, thus achieving the advantage of lightening the computational load compared to a situation where the different system includes the computational processing system 10.

Naturally, the output unit 2 (i.e., the computational processing system 10) does not have to be configured to output the two or more types of physical quantities x₁, . . . , xₜ to the different system. That is to say, the computational processing system 10 does not have to be provided as an independent system but may be incorporated into the different system.

(5) Variations

Note that the embodiment described above is only one of various embodiments of the present disclosure and should not be construed as limiting. Rather, the embodiment described above may be readily modified in various manners depending on a design choice or any other factor without departing from the scope of the present disclosure. The functions of the computational processing system 10 may also be implemented as a computational processing method, a computer program, or a storage medium on which the program is stored, for example.

A computational processing method according to an aspect includes: computing, based on a plurality of detection signals DS₁, . . . , DSₙ received from a sensor group AG that is a set of a plurality of sensors A1, . . . , Ar, two or more types of physical quantities x₁, . . . , xₜ, out of multiple types of physical quantities x₁, . . . , xₖ included in the plurality of detection signals DS₁, . . . , DSₙ, by using a learned neural network NN1; and outputting the two or more types of physical quantities x₁, . . . , xₜ thus computed.

A program according to another aspect is designed to cause one or more processors to perform the computational processing method described above.

Next, variations of the embodiment described above will be enumerated one after another. Note that the variations to be described below may be adopted in combination as appropriate.

The computational processing system 10 according to the present disclosure includes a computer system (including a microcontroller) in its computing unit 3, for example. The microcontroller is an implementation of a computer system made up of one or more semiconductor chips and having at least a processor capability and a memory capability. The computer system may include, as principal hardware components, a processor and a memory. The functions of the computational processing system 10 according to the present disclosure may be performed by making the processor execute a program stored in the memory of the computer system. The program may be stored in advance in the memory of the computer system. Alternatively, the program may also be downloaded through a telecommunications line or be distributed after having been recorded in some storage medium such as a memory card, an optical disc, or a hard disk drive, any of which is readable for the computer system. The processor of the computer system may be made up of a single or a plurality of electronic circuits including a semiconductor integrated circuit (IC) or a largescale integrated circuit (LSI). Those electronic circuits may be either integrated together on a single chip or distributed on multiple chips, whichever is appropriate. Those multiple chips may be integrated together in a single device or distributed in multiple devices without limitation.

In the embodiment described above, the learned neural network NN1 for use in the computing unit 3 is implemented as a resistive (in other words, analog) neuromorphic element 30. However, this is only an example of the present disclosure and should not be construed as limiting. Alternatively, the learned neural network NN1 may also be implemented as a digital neuromorphic element using a crossbar switch array, for example.

In the embodiment described above, the learned neural network NN1 for use in the computing unit 3 is implemented as the neuromorphic element 30. However, this is only an example of the present disclosure and should not be construed as limiting. Alternatively, the computing unit 3 may also be implemented by loading the learned neural network NN1 into an integrated circuit such as a field-programmable gate array (FPGA). In that case, the computing unit 3 includes one or more processors used in the learning phase and performs computational processing in the deduction phase by using the learned neural network NN1. Optionally, the computing unit 3 may perform the computational processing using one or more processors having lower processing performance than one or more processors used in the learning phase. This is because the processing performance required for the one or more processors in the deduction phase is not as high as the processing performance required in the learning phase.

In the embodiment described above, if the computing unit 3 has the capability of performing learning in the learning phase, re-learning of the learned neural network NN1 may be performed. That is to say, according to this implementation, re-learning of the learned neural network NN1 may be performed in a place where the computational processing system 10 is used, instead of the learning center.

In the embodiment described above, the two or more types of physical quantities x₁, . . . , xₜ output from the output unit 2 include at least two types of physical quantities selected from the group consisting of acceleration, angular velocity, temperature, and the stress applied to one or more sensors out of the plurality of sensors A1, . . . , Ar. However, this is only an example of the present disclosure and should not be construed as limiting. That is to say, the two or more types of physical quantities x₁, . . . , xₜ may include only physical quantities other than the ones cited above.

In the embodiment described above, not every one of the plurality of sensors A1, . . . , Ar has to have sensitivity to all of the n types of physical quantities x₁, . . . , xₙ. That is to say, the sensor group AG that is a set of the plurality of sensors A1 just needs to have sensitivity to all of the n types of physical quantities x₁, . . . , xₙ. Therefore, the plurality of sensors A1, . . . , Ar may be sensors dedicated to detecting mutually different physical quantities.

In the embodiment described above, the plurality of sensors A1 . . . , , Ar are placed in the same environment. However, this is only an example of the present disclosure and should not be construed as limiting. Alternatively, the plurality of sensors A1, . . . , Ar may also be placed separately in two or more different environments. For example, if the plurality of sensors A1, . . . , Ar are placed in the vehicle cabin of a vehicle such as an automobile, for example, then the plurality of sensors A1, . . . , Ar may be placed separately in front and rear parts of the vehicle cabin.

In the embodiment described above, the plurality of sensors A1, . . . , Ar are implemented on the same board. Alternatively, the plurality of sensors A1, . . . , Ar may also be implemented separately on a plurality of boards. In that case, the plurality of sensors A1, . . . , Ar separately implemented on the plurality of boards are suitably placed in the same environment.

In the embodiment described above, the plurality of sensors A1, . . . , Ar are all implemented as MEMS devices. However, this is only an example of the present disclosure and should not be construed as limiting. Alternatively, at least some of the plurality of sensors A1, . . . , Ar may also be implemented as non-MEMS devices. That is to say, at least some of the plurality of sensors A1, . . . , Ar do not have to be implemented on the board but may be directly mounted on a vehicle such as an automobile.

In the embodiment described above, the output unit 2 outputs two or more types of physical quantities x₁, . . . , xₜ. Alternatively, the output unit 2 may also be configured to finally output a single type of physical quantity based on the two or more types of physical quantities x₁, . . . , xₜ. For example, if the output unit 2 outputs acceleration and temperature as two types of physical quantities, then the output unit 2 may finally output acceleration as the single type of physical quantity by using temperature to compensate for acceleration. In this manner, the output unit 2 may output only a single type of physical quantity instead of outputting two or more types of physical quantities x₁, . . . , xₜ.

In the embodiment described above, the plurality of detection signals DS₁, . . . , DSₙ may be received by the input unit 1 either in synch with each other or at mutually different timings time sequentially. In the latter case, by defining a period between a point in time when the first one of the plurality of detection signals DS₁, . . . , DSₙ is received and a point in time when the last detection signal is received as one cycle, for example, the computing unit 3 outputs two or more types of physical quantities x₁, . . . , xₜ by performing the computational processing on a cycle-by-cycle basis.

(Resume)

As can be seen from the foregoing description, a computational processing system (10) according to a first aspect includes an input unit (1), an output unit (2), and a computing unit (3). The input unit (1) receives a plurality of detection signals (DS₁, . . . , DSₙ) from a sensor group (AG) that is a set of a plurality of sensors (A1, . . . , Ar). The output unit (2) outputs two or more types of physical quantities (x₁, . . . , xₜ) out of multiple types of physical quantities (x₁, . . . , xₖ) included in the plurality of detection signals (DS₁, . . . , DSₙ). The computing unit (3) computes, based on the plurality of detection signals (DS₁, . . . , DSₙ) received by the input unit (1), the two or more types of physical quantities (x₁, . . . , xₜ) by using a learned neural network (NN1).

This aspect achieves the advantage of allowing, when receiving detection signals (DS₁, . . . , DSₙ) from a sensor group (AG) having sensitivity to multiple types of physical quantities (x₁, . . . , xₖ), an arbitrary physical quantity (x₁, . . . , xₜ) to be extracted from the detection signals (DS₁, . . . , DSₙ).

In a computational processing system (10) according to a second aspect, which may be implemented in conjunction with the first aspect, the computing unit (3) includes a neuromorphic element (30).

This aspect achieves the advantages of contributing to speeding up the computational processing compared to simulating the neural network (NN1) by means of software and cutting down the power consumption involved with the computational processing.

In a computational processing system (10) according to a third aspect, which may be implemented in conjunction with the second aspect, the neuromorphic element (30) includes a resistive element representing, as a resistance value, a weighting coefficient (w₁, . . . , wₙ) between neurons (NE1) in the neural network (NN1).

This aspect achieves the advantages of contributing to speeding up the computational processing compared to a digital neuromorphic element and also cutting down the power consumption involved with the computational processing.

In a computational processing system (10) according to a fourth aspect, which may be implemented in conjunction with any one of the first to third aspects, the plurality of sensors (A1, . . . , Ar) are placed in the same environment.

This aspect achieves the advantage of allowing an arbitrary physical quantity (x₁, . . . , xₜ) to be extracted more easily from multiple types of physical quantities (x₁, . . . , xₖ) than in a situation where the plurality of sensors (A1, . . . , Ar) are placed in mutually different environments.

In a computational processing system (10) according to a fifth aspect, which may be implemented in conjunction with any one of the first to fourth aspects, the two or more types of physical quantities (x₁, . . . , xₜ) include at least two types of physical quantities selected from the group consisting of acceleration, angular velocity, temperature, and stress that is applied to one or more sensors (A1, . . . , Ar) out of the plurality of sensors (A1, . . . , Ar).

This aspect achieves the advantage of making mutually correlated physical quantities extractible.

In a computational processing system (10) according to a sixth aspect, which may be implemented in conjunction with any one of the first to fifth aspects, the output unit (2) outputs the two or more types of physical quantities (x₁, . . . , xₜ) to a different system. The different system is provided separately from the computational processing system (10) and performs processing on the two or more types of physical quantities (x₁, . . . , xₜ) received.

This aspect achieves the advantage of allowing the computational load to be lightened compared to a situation where the different system includes the computational processing system (10).

A sensor system (100) according to a seventh aspect includes the computational processing system (10) according to any one of the first to sixth aspects and the sensor group (AG).

This aspect achieves the advantage of allowing, when receiving detection signals (DS₁, . . . , DSₙ) from a sensor group (AG) having sensitivity to multiple types of physical quantities (x₁, . . . , xₖ), an arbitrary physical quantity (x₁, . . . , xₜ) to be extracted from the detection signals (DS₁, . . . , DSₙ).

A computational processing method according to an eighth aspect includes: computing, based on a plurality of detection signals (DS₁, . . . , DSₙ) received from a sensor group (AG) that is a set of a plurality of sensors (A1, . . . , Ar), two or more types of physical quantities (x₁, . . . , xₜ), out of multiple types of physical quantities (x₁, . . . , xₖ) included in the plurality of detection signals (DS₁, . . . , DSₙ), by using a learned neural network (NN1); and outputting the two or more types of physical quantities (x₁, . . . , thus computed.

This aspect achieves the advantage of allowing, when receiving detection signals (DS₁, . . . , DSₙ) from a sensor group (AG) having sensitivity to multiple types of physical quantities (x₁, . . . , xₖ), an arbitrary physical quantity (x₁, . . . , xₜ) to be extracted from the detection signals (DS₁, . . . , DSₙ).

A program according to a ninth aspect is designed to cause one or more processors to perform the computational processing method according to the eighth aspect.

This aspect achieves the advantage of allowing, when receiving detection signals (DS₁, . . . , DSₙ) from a sensor group (AG) having sensitivity to multiple types of physical quantities (x₁, . . . , xₖ), an arbitrary physical quantity (x₁, . . . , xₜ) to be extracted from the detection signals (DS₁, . . . , DSₙ).

Note that constituent elements according to the second to sixth aspects are not essential constituent elements for the computational processing system (10) but may be omitted as appropriate.

### REFERENCE SIGNS LIST

1 Input Unit
2 Output Unit
3 Computing Unit
30 Neuromorphic Element
10 Computational Processing System
100 Sensor System
A1, . . . , Ar Sensor
AG Sensor Group
DS₁, . . . , DSₙ Detection Signal
NE1 Neuron
NN1 Neural Network
x₁, . . . , xₜ, . . . , xₖ Physical Quantity
w₁, . . . , wₙ Weighting Coefficient

1. A computational processing system comprising:
an input unit configured to receive a plurality of detection signals from a sensor group that is a set of a plurality of sensors;
an output unit configured to output two or more types of physical quantities out of multiple types of physical quantities included in the plurality of detection signals; and
a computing unit configured to compute, based on the plurality of detection signals received by the input unit, the two or more types of physical quantities by using a learned neural network.

2. The computational processing system of claim 1, wherein
the computing unit includes a neuromorphic element.

3. The computational processing system of claim 2, wherein
the neuromorphic element includes a resistive element configured to represent, as a resistance value, a weighting coefficient between neurons in the neural network.

4. The computational processing system of claim 1, wherein
the plurality of sensors are placed in the same environment.

5. The computational processing system of claim 1, wherein
the two or more types of physical quantities include at least two types of physical quantities selected from the group consisting of acceleration, angular velocity, temperature, and stress that is applied to one or more sensors out of the plurality of sensors.

6. The computational processing system of claim 1, wherein
the output unit is configured to output the two or more types of physical quantities to a different system, the different system being provided separately from the computational processing system and configured to perform processing on the two or more types of physical quantities received.

7. A sensor system comprising:
the computational processing system of claim 1; and
the sensor group.

8. A computational processing method comprising:
computing, based on a plurality of detection signals received from a sensor group that is a set of a plurality of sensors, two or more types of physical quantities, out of multiple types of physical quantities included in the plurality of detection signals, by using a learned neural network; and
outputting the two or more types of physical quantities thus computed.

9. A non-transitory computer-readable recording medium recording a program designed to cause one or more processors to perform the computational processing method of claim 8.
